(19) United States
(12) Patent Application Publication
(10) Pub. No.: US 2002/0020314 A1
(43) Pub. Date: Feb. 21, 2002

(54) Device for applying pressing force onto a roller of a printing press and a printing press with such a device

(76) Inventor: Lennardt Jader, Strande (DE)

Correspondence Address: Lawrence P. Kessler, NexPress Solutions LLC, Patent Department, 1447 St. Paul Street, Rochester, NY, 14653-7103, US

(21) Appl. No.: 09/850,046

(22) Filed: May 7, 2001

(30) Foreign Application Priority Data
May 18, 2000 (DE) 100 24 092.5
Dec. 1, 2000 (DE) 100 59 889.7

(51) Int. Cl. B41F 5/00; B41F 7/00

(52) U.S. Cl. 101/216

(57) ABSTRACT

The invention concerns a device for applying a pressing force (3) onto a roller (10, 10′, 10″, 10′″) of a printing press (2) and a printing press (2) with such a device.

Such a devices is designed so that a constant pressing force can be achieved over the width of the rollers at low expense. This is achieved by the fact that the roller (1, 1′, 1″, 1′″) is mounted capable of turning on one end of two two-arm levers (4, 5), that the two-arm levers (4, 5) are mounted capable of turning on side parts (6, 7), and that a cross-connection (8) is located at the other ends of the two-arm levers (4, 5), with which at least one force-generating element (9, 9′, 9″) engages.

### DESCRIPTION

The invention concerns a device for applying pressing force onto a roller of a printing press and a printing press with such a device.

In the case of printing machines pressing force often must be applied to rollers, in many cases it being decisive for the print quality that the pressing force is constant over the width of such a roller.

Back-up rollers, which are used to press printing substrates fed by a carrier against the cylinders of several printing modules, in order to transfer the partial color images created by the printing modules onto the printing substrate as uniformly and register-exact as possible, are an important example of such rollers.

For the above-mentioned purpose it is known to press back-up rollers against the cylinders either individually by means of sprints or to arrange all of the back-up rollers on a carrier element and to act upon the latter with springs, so that the back-up rollers are pressed against the cylinders together. In both arrangements the pressing force is created by the fact that a corresponding force is transferred directly by the springs to bearings of the back-up rollers mounted capable of moving. However, a constant pressing force over the width of the rollers cannot be achieved satisfactorily in this way, in particular not if it its necessary in a very precise way because of a required high printing quality.

Furthermore it is know to use active actuators which receive this direct action of force on movably mounted bearings of rollers. With this it is indeed possible to achieve an essentially more constant pressing force over the width of the rollers, however this entails a great expense for costly sensors and controls.

Therefore the object of the invention is to make a device of the type mentioned initially in such a way that a constant pressing force can be exerted over the width of the rollers at low expense.

The object is achieved according to the invention by means of the fact that the roller is mounted capable of turning on one end of two two-arm levers, that the two-arm levers are mounted capable of turning on side parts, and that a cross-connection is located at the other ends of the two-arm levers, with which at least one force-generating element engages.

By means of the lever transfer of the forces according to the invention these are distributed uniformly to the respective rollers. In this case also irregularities in the dimensions of rollers or the elements interacting therewith are absorbed, also shocks, which arise, for example, by front or rear edges of printing substrates.

These advantages are achieved by improvements and advantageous embodiments in an even better way; further advantages are indicated.

The force-generating element can be made in different ways. One proposal provides that the force-generating element is made for applying a permanent force, which is determined so that the pressing force arises via the two-arm lever. For example, a permanent force can be generates sot that the force-generating element is a weight. A force generated in this way is always constant, scarcely has position-dependent differences and no hysteresis, as in the case with springs.

Different pressing forces can be set in such a way that there is a further force-generating through which a force acting opposite the permanent force can be generated. By means of an opposing force of this kind the pressing force can be switched off if the first is greater than the weight force. Switching off the force in this way has the advantage that in the case of a shutdown of the machine a permanent deformation of surfaces cannot be produced by the action of force continuing over a long time.

Preferably the force-generating element for the opposite force is a pneumatic cylinder. The latter can be controlled well with respect to the pressing force as well as switching a roller on and off, and may be made in such a way that it acts simultaneously as a damping element. In this way the appearance of oscillations is prevented, for example those which could be excited by pressure substrate leading edged or rear edges.

An alternative embodiment of the force-generating element provides that the later is designed for the application of a variable force, the latter being capable of being adjusted so that a desired pressing force can be achieved. Preferably the variable force also can be adjusted so that the pressing force can be switched off, therefore the roller can be moved away from the element interacting with it. This also is used for preventing the already above-mentioned deformation of surfaces.

If a force-generating element is located centrally on a cross-connection, a very constant pressing force along a roller is achieved in a simple way.

The variable force also preferably is generated by means of a pneumatic cylinder, with which different forces such as switching a roller on and off can be achieved. In this way also a good damping effect can be achieved by the pneumatic cylinder.

If the cross-connection is made as a spring element, a particularly good absorption of shocks and pressure variations as well as a very good compensation of irregularities is achieved. This purpose also is served if the cross-connection is connected capable of turning with the levers, in which case the cross-connection should be pass parallel to the roller.

In addition to making the above-mentioned pneumatic cylinders as damping elements, of course separate damping elements also can be installed. Vibrations also are prevented if the bearings of the levers are made as slide bearings in the side parts. The side parts can be housing walls or separate components, which are connected with housing walls.

A particularly advantageous application of the device provides for using the latter for pressing on the back-up roller, generating the pressing force which is necessary for an optimal transfer of partial color images onto a printing substrate. Of course there are further areas of application of the invention in a printing press. However, the above-mentioned use is particularly significant, since uniform and precise force adjustment plays a decisive role for the printing quality. Therefore it is also proposed to equip a printing press, in particular an electro-photographic printing press, with an above-mentioned device, the rollers being located on a carrier for printing substrates lying opposite cylinders, which are made for transferring the partial color images onto printing substrates.

Of course, the above-mentioned embodiments are only examples. For example, other force-generating elements known to the expert can be used.

The invention is explained below by means of the drawing. Here:

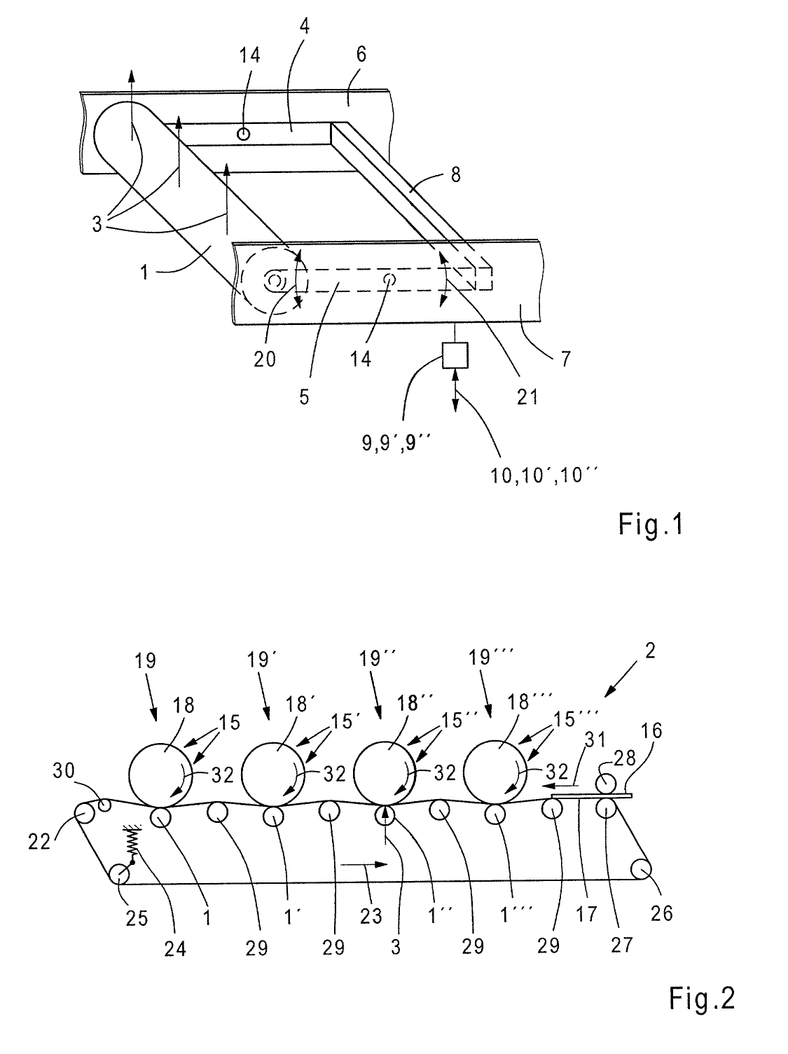

FIG. 1 shows a basic diagram of the device according to the invention.

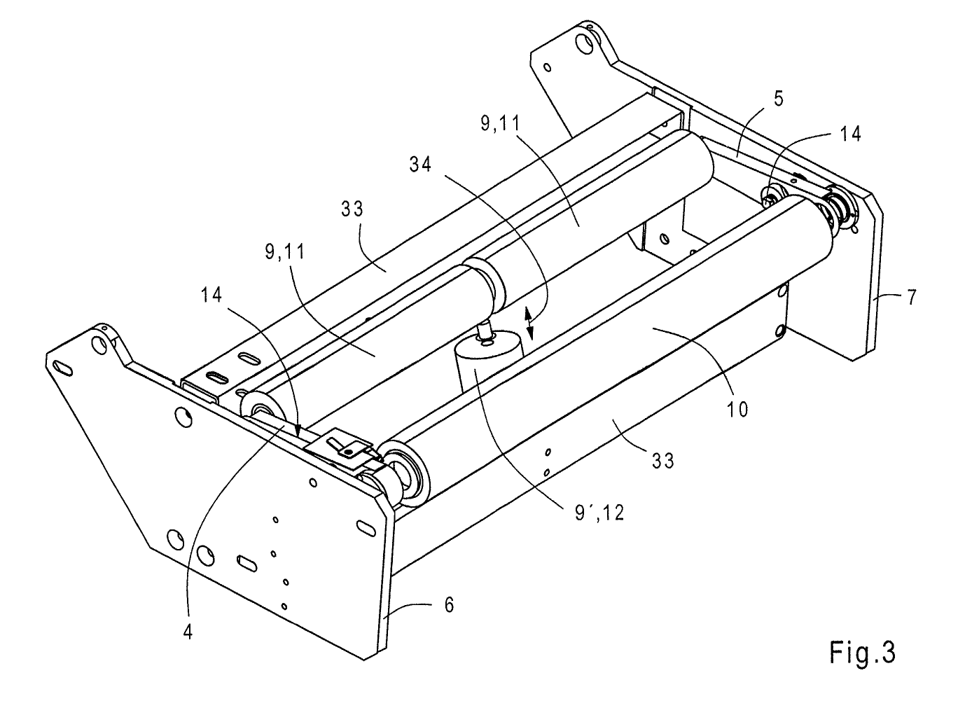

FIG. 2 shows a diagram of a printing press with transport of the printing substrate by means of a carrier,

FIG. 3 shows an embodiment of the device according to the invention and

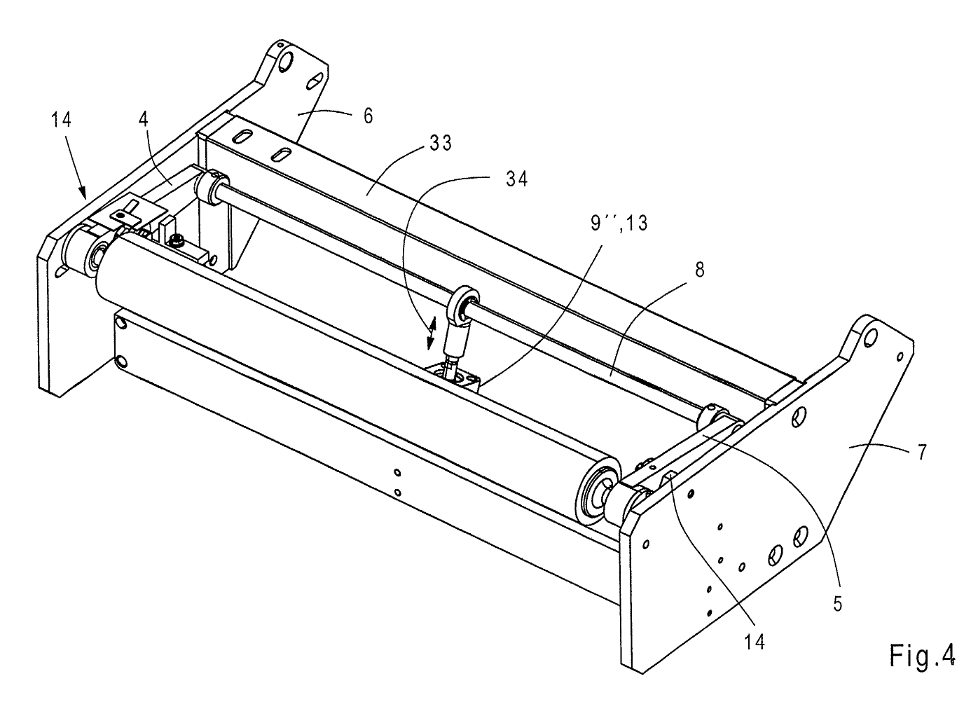

FIG. 4 shows a further embodiment of the device according to the invention.

FIG. 1 shows a basic diagram of the device according to the invention. In order to apply a pressing force 3 onto a roller 1 the latter is mounted on one end of two two-arm levers 4,5. The two-arm levers 4, 5 are mounted on side parts 6 and 7 by means of bearings 14. On the other ends of the two-arm levers 4, 5 there is a cross-connection 8, which is acted upon by a force-generating lever 9, 9′, 9″ with a force 10, 10′, 10″. This may be a force-generating element 9′ for generating a permanent force 10, a force-generating element 9′ for generating a force 10′ directed opposite the permanent force 10, or a force-generating element 9″ for generating a variable force 10″. The representation here is of a symbolic nature; it is presented in greater detail below.

The adjusting motion of the roller 1′ is shown by means of a double arrow 20 and the adjusting motion of the opposite ends of the lever 4, 5 with the double arrow 21. Forces 10, 10′, 10″ and adjusting motions 20 and 21 are used for acting upon a component, not shown here, interacting with the roller 1, with the pressing force 3 symbolized by three arrows. The three arrows 3 should make clear that the pressing force 3 is distributed over the entire width of the roller. This the main purpose of the invention, which is achieved by the fact that the force transfer takes by means of the two-arm lever 4, 5 in such a way that uniform forces act on the roller 1.

The diagram in FIG. 2 shows a printing press 2 with a carrier 17 for transporting printing substrates 16 through the printing press 2 in the direction of the arrow 31. In this case the printing substrates 16 are conveyed from one printing module 19, 19′, 19″, 19′″ to the other, and in this case printed by cylinders 18, 18′, 18″, 18′″ of the printing modules 19, 19′, 19″, 19′″ with partial color images 15, 15′, 15″, 15′″, which together produce the color printing. In this case an exact pressing force 3 and a vibration-free guiding of the printing substrate 16 is necessary. For this purpose the invention proposes rollers 10, 10′, 10″, 10′″, which are mounted according to the principle presented above.

The carrier 17 is placed over a plurality of rollers. A roller 22 is used for driving the carrier 17 in the direction of the arrow 23. A further roller is used as a tightening roller 25. A roller 26 capable of swiveling transverse to its turning axis is provided for lateral adjustment of the belt passage of the carrier 17. A guide roller 27 acts together with a roller28. Roller 28 is used for placing printing substrates 16 which are to be printed. Guide rollers 29 cause a certain wrapping around cylinders 18, 18′, 18″, 18′″, which corresponding to the partial color images 15, 15′, 15″, 15′″ bear a printed image in the form of toner particles for transfer onto the printing substrate 16. In this case the cylinders 15, 15′, 15″, 15′″ can be provided with the toner particles directly or via further cylinders (not shown). The arrows 32 show the direction of turning of the cylinders 15, 15′, 15″, 15′″.

Thus during the printing operation a definite pressing is present between the carrier 17 with the printing substrates 16 located thereon and the cylinders 18, 18′, 18″, 18′″, rollers 10, 10′, 10″, 10′″ made as back-up rollers are provided with can be switched on and off against the underside of the carrier 17. A further roller 30 is used for removing a printing substrate 16 from the carrier 17.

FIG. 3 shows an embodiment of the device according to the invention with force-generating elements 9 and 9′, which are made as a weight 22 and as a pneumatic cylinder 12. The weight 11 pulls downward and thus generates the pressing force 3 of the roller 10. For regulating this pressing force 3 or for switching off the pressing, the element 9′ is used for generating the counter-force 10′. This element 9′ is made as a pneumatic cylinder 12. The adjusting motion of the pneumatic cylinder 12 is indicated by means of the double arrow 34. If the pneumatic cylinder 12 is not active, the pressing force 3 is generated by the weight 11. Both two-arm levers 4, 5, are fastened to side parts 6, 7, which are connected together by means of cross-pieces 33. In this way the device is designed so that it can be inserted as a whole into a machine, for example by fastening the side parts 6, 7 in the machine. With respect to the other functions and the other components, the basic embodiments above are to be consulted.

FIG. 4 shows a further embodiment of the invention, in the case of which an element 9″ is used for generating a variable force 10″. This element is a pneumatic cylinder 13, which is located in the middle of the cross-connection 8. The cross-connection 8 is suspended capable of turning on the two-arm levers 4, 5 and has spring properties. These measures produce an very good force distribution and absorption of shocks and other stresses. In the case of this configuration it is important that the pneumatic cylinder 13 have damping properties. Here also the levers 4, 5 are mounted by means of bearings 14 in side parts 6, 7, which are connected with one another by means of cross-pieces 33. The adjusting motion of the pneumatic cylinder 13 is indicted by means of the double arrow 34. In this case the pneumatic cylinder 13 applies the entire force which is necessary in order to set the pressing force 3. Furthermore, the pneumatic cylinder 13 id made in such a way that it can switch the roller 10 on and off. Here also the basic embodiment mentioned above is to be consulted with respect to further elements and functions.

1. A device for applying a pressing force (3) onto a roller (1, 1′, 1″, 1′″) of a printing press (2), wherein the roller (1, 1′, 1″, 1′″) is mounted capable of turning on one end of two two-arm levers (4, 5), that the two-arm levers (4, 5) are mounted capable of turning on side parts (6, 7), and that a cross-connection (8)is located at the other ends of the two-arm levers (4, 5), with which at least one force-generating element (9, 9′, 9″) engages.

2. The device according to claim 1, wherein the force-generating element (9) is designed for applying a permanent force (10), which is determined so that the pressing force (3) arises vis the two-arm lever (4, 5).

3. The device according to claim 2, wherein the force-generating element (9) is a weight (1).

4. The device according to claim 2 or 3, wherein there is a further force-generating element (9′) through which a force (10′) acting opposite the permanent force (10) can be generated.

5. The device according to claim 4, wherein the opposing force (10′) is used for adjusting the pressing force (3).

6. The device according to claim 4 or 5, wherein the opposing force (10′) is used for switching off the pressing force (3).

7. The device according to one of the claims 4 to 6, wherein the force-generating element (9′) is a pneumatic cylinder (12).

8. The device according to claim 1, wherein the force-generating element (9″) is designed for applying a variable force (10″), the latter being adjustable so that a desired pressing force (3) can be achieved.

9. The device according to claim 8, wherein the variable force (10″) is adjustable so that the pressing force (3) is switched off.

10. The device according to claim 8 or 9, wherein a force-generating element (9″) is located in the middle on the cross-connection (8).

11. The device according to one of the claims 8 to 10, wherein the force-generating element (9″) is a pneumatic cylinder (13).

12. The device according to one of the claims 1 to 11, wherein the cross-connection (8) is made as an elastic element.

13. The device according to one of the claims 1 to 12, wherein the cross-connection (8) is connected capable of turning with the levers(4,5).

14. The device according to one of the claims 1 to 13, wherein the damping elements are mounted for damping roller vibrations.

15. The device according to one of the claims 7 or 11 to 14, wherein the pneumatic cylinder (12 or 13) is made acting as a damping element.

16. The device according to one of the claims 1 to 15, wherein the bearings (14) of the levers (4, 5) are made in the side parts (6, 7) as sliding bearings.

17. The device according to one of the claims 1 to 16, wherein the rollers (1, 1′, 1″, 1′″) are back-up rollers for generating the pressing force (3) for the transfer of partial color images (15, 15′, 15″, 15′″) onto a printing substrate (16) and the pressing force (3) is determined in order to perform this transfer.

18. A printing press (2), in particular an electrophotographic printing press, with a device according to claim 17, wherein the rollers (1, 1′, 1″, 1′″) are mounted on a carrier (17) for printing substrates lying opposite cylinders (18, 18′, 18″, 18′″), which are designed for transferring partial color images (15, 15′, 15″, 15′″) onto printing substrates (16).
